(19) United States
(12) Patent Application Publication
(10) Pub. No.: US 2011/0060498 A1
(43) Pub. Date: Mar. 10, 2011

(54) DATA RECOVERY APPARATUS AND SYSTEM

(76) Inventors: John L. Cannon, Albuquerque, NM (US); William R. Gibson, Albuquerque, NM (US)

(21) Appl. No.: 12/833,680

(22) Filed: Jul. 9, 2010

Related U.S. Application Data
(60) Provisional application No. 61/224,670, filed on Jul. 10, 2009.

(51) Int. Cl. G06F 19/00

(52) U.S. Cl. 701/35

(57) ABSTRACT

A recoverable, ejectable, data-recording apparatus is configured to record information from multiple recording instruments that are configured to record operating data associated with a moving vehicle. The ejectable apparatus includes means for connecting an ejectable apparatus in parallel to a plurality of data recording instruments in a host vehicle. The ejectable apparatus also includes means for separately storing information received from each of the plurality of data recording instruments for a predefined time period in a memory unit of the apparatus. The ejectable apparatus may further include means for monitoring for occurrence of a predefined criterion which may prior to an occurrence of a catastrophic event involving the host vehicle. The ejectable apparatus may also include means for separating portions of the ejectable apparatus from the host vehicle upon detection of a predefined criterion.

The present application claims the benefit under 35 U.S.C. 119(e) of U.S. Patent Application No. 61/224,670 filed on Jul. 10, 2009, the contents of which is incorporated by reference herein.

### BACKGROUND OF THE INVENTION

1. Field of the Invention

The present invention is directed to an apparatus and system for the preservation and recovery of data. More particularly, the invention relates to systems and devices wherein a recoverable, ejectable, data-recording apparatus is configured to record information from a plurality of data recording instruments, wherein each of the plurality of recording instruments is configured to record operating data associated with a host. The host can take various forms and may include moving vehicles such as airplanes, spacecraft, and vehicles, satellites and the like.

2. Description of the Related Art

All vehicles operating on land, sea or air are potentially subject to catastrophic events that may lead to the destruction and/or disablement of the vehicle, such as crashes by way of non-limiting example. To determine the causes of these crashes some vehicles, for example aircraft and spacecraft, include instruments for recording operating data associated with the moving host vehicle. For example, a flight data recorder is typically installed in an aircraft for recording flight information and critical events leading up to a crash. The flight data recorder is configured to be recoverable in the event of an accident to determine what caused the crash. In addition to the flight data recorder, an aircraft also may include other recorders such as a cockpit voice recorder and a cockpit image recorder for recording sounds and activities that occur in the cockpit of the airplane.

Each of these recording instruments is designed to survive a crash and is made of strong durable materials with heat protection. However, depending on the impact associated with the crash, one or more of these recording instruments may be damaged during the crash and may require repairs before useful or relevant information can be obtained. Even if no recording instrument is destroyed, the instruments must still be found after a crash in order to recover the recorded data. This can be a problem in a crash where the debris from the crash may be unrecoverable, for example, at the bottom of an ocean. Although these recording instruments may include location indicators, for example broadcast beacons that are used to indicate the location the recording instrument, the location indicators may not work in certain extreme terrains, such as the bottom of an ocean.

In those situations where one or all of the recording instruments are unrecoverable, it may be quite difficult, and in some cases impossible, to determine the cause of a crash. This may result in various consequences, human and commercial, and, for example, may delay remediation of safety issues, determination of negligence and/or fault, and resolution of the foregoing including insurance issues.

Similar to aircrafts, spacecraft are also subject to collisions. Because the recording instructions on spacecrafts may be unrecoverable after a crash, spacecraft often use onboard in-flight sensors and communication systems for continuous transmission of sensory and telemetry data to a ground recording system. The continuous transmission method typically fails when the communications downlink fails during a crash.

### SUMMARY OF THE INVENTION

The foregoing and other advantages may be accomplished in illustrative embodiments of the present invention, such as embodiments including a recoverable, ejectable, data-recording apparatus configured to record information from multiple recording instruments that are configured to record operating data associated with a moving vehicle.

An embodiment of the present invention may be directed to an ejectable apparatus, including a connection module configured to connect the ejectable apparatus in parallel to a plurality of data recording instruments in a host vehicle. The ejectable apparatus may also include an ejectable module configured to be separated from the host vehicle upon detection of a predefined criterion. The predefined criterion may occur prior to an occurrence of a catastrophic event involving the host vehicle. The ejectable apparatus may further include a memory unit configured to separately store information received from each of the plurality of data recording instruments for a predefined time period. The ejectable apparatus also may include a device locator configured to indicate a position of ejected portions of the ejectable apparatus and an ejection unit configured to separate portions of the ejectable apparatus from the host vehicle upon occurrence of at least one predefined criterion. It should be noted that the at least one predefined criterion may include any criterion and/or event that is pre-defined to trigger the separation of portions of the ejectable apparatus from the host vehicle.

Another embodiment of the present invention may be directed to a method including connecting an ejectable apparatus in parallel to a plurality of data recording instruments in a host vehicle; separately storing information received from each of the plurality of data recording instruments for a predefined time period in a memory unit of the apparatus; monitoring for occurrence of a predefined criterion that may occur prior to a catastrophic event involving the host vehicle; and separating portions of the apparatus from the host vehicle upon detection of the predefined criterion.

Another embodiment of the present invention may be directed to an ejectable apparatus including means for connecting the ejectable apparatus in parallel to a plurality of data recording instruments in a host vehicle; means for separately storing information received from each of the plurality of data recording instruments for a predefined time period in a memory unit of the ejectable apparatus; means for monitoring for occurrence of a predefined criterion that may occur prior to a catastrophic event involving the host vehicle; and means for separating portions of the ejectable apparatus from the host vehicle upon detection of the predefined criterion.

### BRIEF DESCRIPTION OF THE DRAWINGS

For a better understanding of the present invention, reference may be made to the following detailed description of certain embodiments of the present invention taken in conjunction with the exemplary drawings, in which:

FIG. 1 illustrates an example of how the ejectable, data recording apparatus may be used in conjunction with other data recoding instruments;

FIG. 2 illustrates an embodiment of the ejectable, data recording apparatus;

FIG. 3 illustrates another embodiment of the ejectable, data recording apparatus;

FIG. 4 illustrates an embodiment of the memory unit used in an embodiment of the ejectable, data recording apparatus;

FIG. 5 illustrates yet another embodiment of the ejectable, data recording apparatus; and

FIG. 6 illustrates an embodiment of the steps implemented by the ejectable, data recording apparatus.

### DETAILED DESCRIPTION OF EMBODIMENTS

Referring now more particularly to the drawings, therein is illustrated a recoverable, ejectable, data-recording apparatus configured to record information from multiple data recording instruments. The ejectable, data-recording apparatus may be configured to remove high value information a safe distance from a host vehicle prior to occurrence of a catastrophic event that would otherwise destroy, render inaccessible and/or unrecoverable, all recording instruments attached to the host vehicle. High value information may include any information determined to be valuable such as information that could assist in determining the cause of the catastrophic event, by way of non-limiting example only.

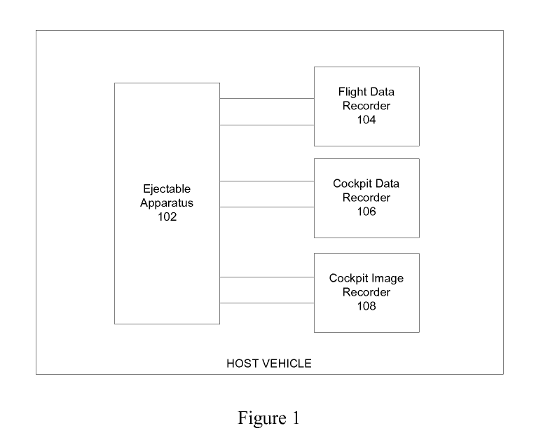

FIG. 1 illustrates an example of how such an ejectable, data recording apparatus may be used in conjunction with other data recoding instruments. In an embodiment of the invention, a host vehicle may include multiple data recording instruments 104-108, each of which is configured to record operating data and flight information associated with the moving host vehicle. An example of a data recording instruments may include a flight data recorder 104, a cockpit data recorder 106 or a cockpit image recorder 108. The ejectable, data recording apparatus 102 may be directly connected to each data recording instrument 104-108. It should be apparent to one skilled in the art that the connections between apparatus 102 and data recording instruments 104-108 need not be a wired connection. Units 102-108 may be connected by other mechanism, such as known wireless techniques and apparatus.

Unlike recording instruments that are configured to remain associated with the host vehicle during a crash, an embodiment of the inventive apparatus 102 may be configured to separate the entire apparatus 102 or portions of apparatus 102 from the host vehicle prior to the crash and upon the occurrence of a predefined criterion. It should be noted that the predefined criterion may include any criterion and/or event information, data or condition (referred to herein collectively as “criterion” or “event”) that is pre-defined to trigger the separation of portions of the apparatus from the host. This enables recoverable portions of apparatus 102 to remain separate from the host vehicle after the crash and intact for recovery of the stored data.

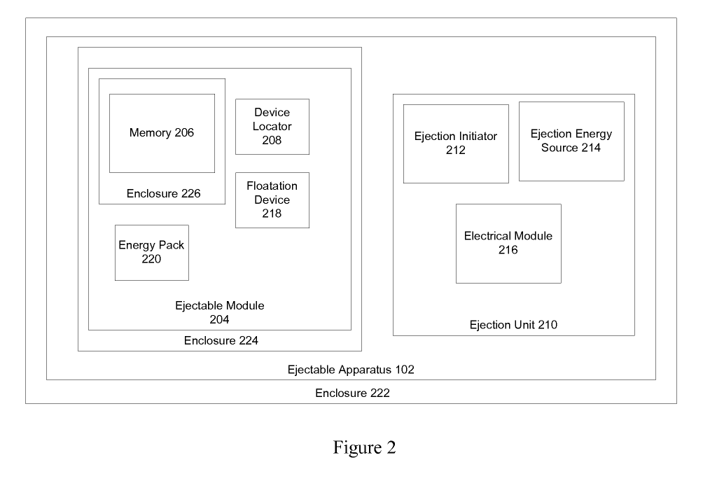

FIG. 2 illustrates an embodiment of an ejectable, data recording apparatus according to an embodiment of the present invention. Unlike a typical flight data recorder which may weigh almost eighteen pounds and require a significant ejection force to separate from the host vehicle, apparatus 102 may be relatively small in size and light in weight. An embodiment of apparatus 102 may include an ejectable module 204 that can be separated from the host vehicle prior to the occurrence of a catastrophic event. For example, ejectable module 204 may be separated from the host vehicle prior to an accident or physical attack. The criterion for defining when ejectable module 204 is to be separated from the host vehicle may be predefined and/or programmable. The predefined criterion may be associated with data and/or the occurrence of an event. For example, ejectable module 204 may be programmed to separate from the host vehicle upon detection by one or more recording instruments of a predefined number of abnormal conditions. In another example, ejectable module 204 may be programmed to separate from the host vehicle at a predefined temperature. In yet another example, ejectable module 204 may be programmed to separate from the host vehicle upon detection of an impact or the presence of water. Ejectable module 204 includes a memory module 206 for separately storing data recorded from one or more connected recording instruments.

Apparatus 102 may also include a device locator 208 for indicating the position of the ejected portions of apparatus 102. In an embodiment of the invention, device locator 208 may be one of a Global Positioning System transmitter and/or receiver, a strobe light, or a dye marker. Apparatus 102 may include an ejection unit 210 for separating portions of apparatus 102 from the host vehicle upon occurrence of at least one predefined criterion.

Ejection unit 210 may include an ejection initiator 212 which is configured to determine the occurrence of at least one predefined criterion and execute separation of portions of the apparatus from the host vehicle. Ejection unit 210 may also include an ejection energy source 214 which is configured to supply constant energy to the ejection unit. Ejection unit 210 may also include an electrical module 216 for enabling an electrical quick disconnect from the host vehicle. The apparatus may further include an inflatable floatation device 218 which may be activated in water. The apparatus may also include an extended life power pack 220 to ensure detection of ejected portions of apparatus 102 for an extended period. The apparatus may further include mechanism(s) to safely allow the ejectable unit(s) to descend from space or air to sea or land in a manner that preserves the viability of the components and data from environmental conditions including impact such as by way of a non-limiting example, a parachute.

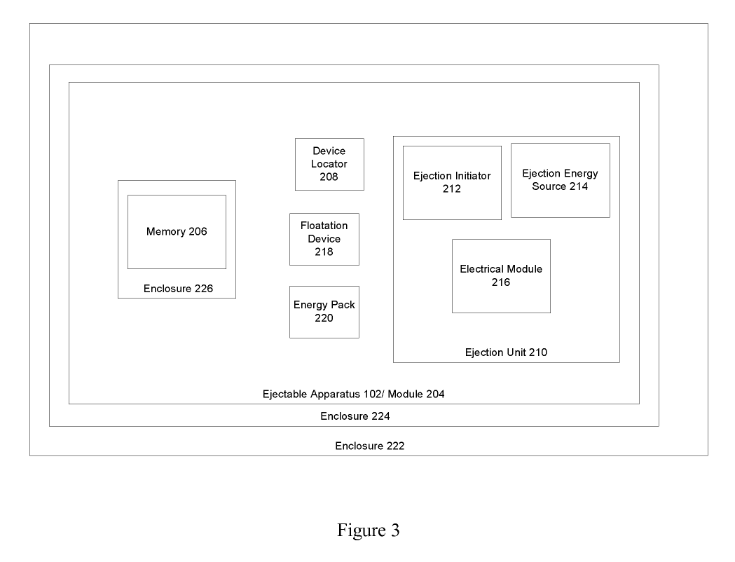

FIG. 3 illustrates another embodiment of the ejectable, data recording apparatus. According to this embodiment of the invention, upon detection of a predetermined criterion, the entire apparatus 102 is ejected from the host vehicle. Hence, in this embodiment there is no separate ejection module as illustrated in FIG. 2. It should be apparent to one skilled in the art, that in any embodiment, apparatus 102 may include at least one processing module (not shown) for implementing the functions required by apparatus 102.

According to an embodiment of the invention, a host vehicle may include multiple ejectable, data recording apparatuses 102. Each apparatus 102 may be separated from the host vehicle upon the occurrence of a specific predefined criterion. Each apparatus 102 may also be configured to record information from predefined data instruments, such that the information recorded on each apparatus 102 is unique. Each apparatus 102 may also be configured to record information from predefined data instruments for a specific period of time.

As is known to one skilled in the art, each of flight data recorder 104, cockpit voice recorder 106, and cockpit image recorder 108 is configured to continuously record data in such a manner as to preserve data created at predetermined times prior to a defined if not catastrophic event. In an embodiment of the invention, data from each of the flight data recorder 104, the cockpit voice recorder 106, and the cockpit image recorder 108 is stored in a dedicated solid state memory unit 206. Memory unit 206 is configured to continuously update stored information to provide recoverable information for a minimum period of time. For example, memory unit 206 may be configured to store a minimum of one hour of operational information recorded on each of the other data recording instruments in the host vehicle.

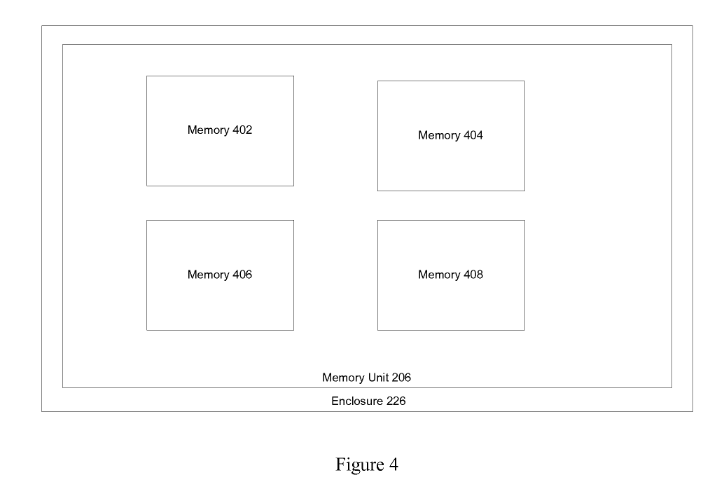

FIG. 4 illustrates an embodiment of the memory unit used in an embodiment of such an ejectable data recording apparatus. Memory unit 206 may be further sub-divided into a pre-determined number of separate sub-memory units 402-408, each of which is configured to store data associated with a specific recorder. For example, sub-memory unit 402 may be configured to store data received from flight data recorder 104, sub-memory unit 404 may be configured to store data received from cockpit voice recorder 106, and sub-memory unit 406 may be configured to store data received from cockpit image recorder 108. Sub-memory unit 408 may be configured to store other critical information that may be collected by apparatus 102 or it may also be configured to store critical information collected from other sources. It should be noted that although four sub-memory units are illustrated in FIG. 4, memory unit 206 may be configured with any number of sub-memory units each of which may operate dependently, interdependently and/or independently of the other. Consistently, in certain embodiments of the invention, data from each recording instrument may be stored in a separate sub-memory unit that is physically and electronically separated from other memory units.

In another embodiment of the invention, memory unit 206 may not include sub-memory units. Instead, memory unit 206 may be configured so that information recorded from each instrument is stored in a specific location in memory unit 206 and is separated from information transmitted from other recording instruments.

An embodiment of apparatus 102 is designed to be accommodated and contained within an electronic enclosure 222 of the type specified for mounting in electronic support racks commonly provided in aircraft. Portions of apparatus 102 may be enclosed in a crash survivable protective enclosure 224. Enclosure 224 may be suitably designed to protect flight data information stored in memory 206 from physical damage resulting from the crash of the host vehicle so that such data or information may be retrieved at a later time and used for the purposes of determining the cause of the crash. Memory 206 may be further enclosed in enclosure 226 formed of lightweight, high strength metal such as titanium alloys and/or stainless steel alloys.

Enclosure 226 may be formed in a variety of different methods such as by casting, forging, metal spinning, and the wall thickness of the enclosure is chosen so as to provide the necessary strength against crushing under the effect of the intense high pressure. Enclosure 226 may be specifically configured to protect the contents of memory 206 from heat, cold, fluid, radio frequency interference and impact. In addition, enclosure 226 may be configured to protect the contents of memory 206 from radio frequency interference from high energy sources, such as search radar, sonar and lasers. It is clear that in the case of digitally recorded vehicle performance data, these energy sources could destroy the very data that is the object of any data recovery attempt.

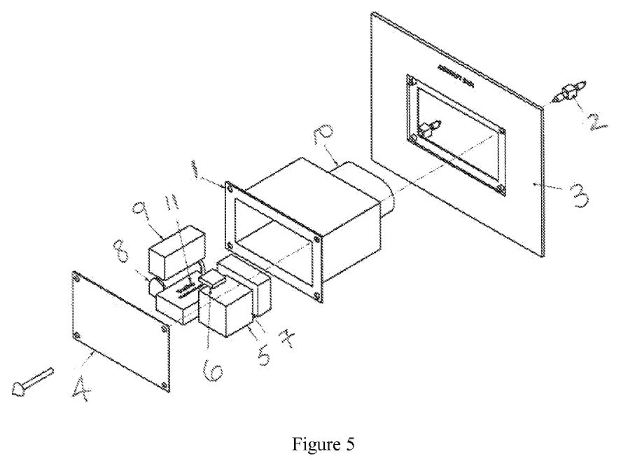

FIG. 5 illustrates yet another embodiment of the ejectable data recording apparatus. The apparatus 102 shown in FIG. 5 may include a mounting hole (1) for a frangible fastener (2). The apparatus also may include a mounting plate (3) for mounting apparatus 102 on a host with frangible fastener (2). A cover plate (4) may be used to cover the mounted apparatus 102. The device locator may include dye marker (5) and/or GPS receiver/transmitter (6) for indicating the position of the ejected portions of apparatus 102. Apparatus 102 may further include a system control interface (7). Inflatable floatation device (8) may be activated in water upon entry of ejected portions of apparatus 102 into water. The apparatus may also include an extended life power pack (9) to ensure detection of ejected portions of apparatus 102 for an extended period. Ejection unit (10) may also be provided for separating portions of apparatus 102 from the host vehicle upon occurrence of at least one predefined criterion. Memory module (11) may also be provided for separately storing data recorded from one or more connected recording instruments.

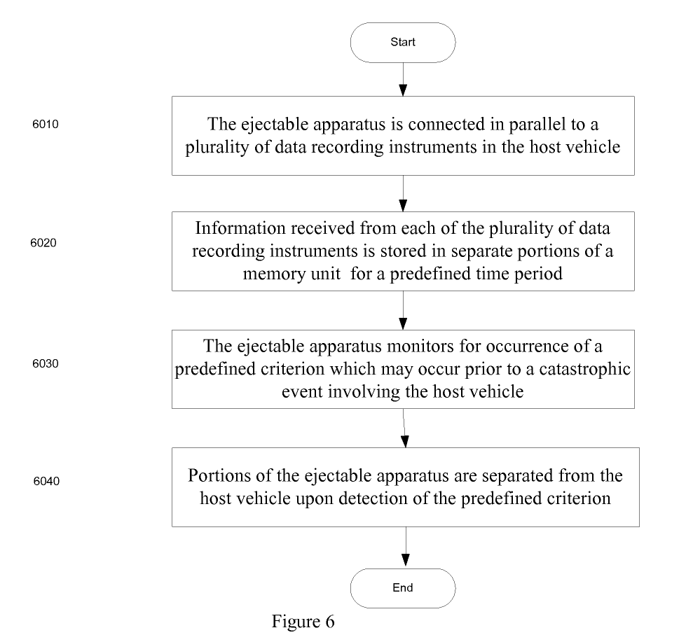

FIG. 6 illustrates steps implemented in an embodiment of the ejectable data recording apparatus. In Step 6010, the ejectable apparatus 102 may be connected in parallel to a plurality of data recording instruments 104-108 in the host vehicle. In Step 6020, information received from each of the plurality of data recording instruments may be stored in memory unit 206, such as in separate portions thereof, for a predefined time period. The information may be stored in a plurality of sub-memory units, each of the sub-memory units may be configured to store information from a specific one of the plurality of data recording instruments. In Step 6030, the ejectable apparatus 102 may monitor for occurrence of a predefined criterion which may occur prior to a catastrophic event involving the host vehicle. In Step 6040, portions of the ejectable apparatus 102 may be separated from the host vehicle upon detection of the predefined criterion. Upon separation of the portions of the ejectable apparatus 102, a device locator may be executed to indicate a position of ejected portions of the apparatus. An inflatable floatation device may also be executed upon entry of portions of the ejectable apparatus into water. Extended life power supply configured to provide power to ejected portions of the apparatus for an extended period may be provided.

Although the present invention has been shown and described with respect to certain embodiments, it should be understood by those skilled in the art that various modifications can be made to the inventive apparatus and the method of operating the same of the invention without departing from the scope and spirit of the invention. Another embodiment might be the ejection of a valuable item, such as gems, historic documents, formulas, and codes. It is intended that the present invention cover modifications and variations of the inventive device and method provided they come within the scope of the appended claims and their equivalents.

What is claimed:

1. An ejectable apparatus, comprising:
a connection module configured to connect the ejectable apparatus in parallel to a plurality of data recording instruments in a host vehicle;
an ejectable module configured to be separated from the host vehicle upon detection of a predefined criterion;
a memory unit configured to separately store information received from each of the plurality of data recording instruments for a predefined time period;
a device locator configured to indicate a position of ejected portions of the ejectable apparatus; and
an ejection unit configured to separate portions of the ejectable apparatus from the host vehicle upon occurrence of at least one predefined criterion.

2. The ejectable apparatus of claim 1, wherein the ejection unit comprises:
an ejection initiator configured to detect the occurrence of the at least one predefined criterion and to execute the separation of portions of the ejectable apparatus from the host vehicle;
an energy source configured to provide a constant supply of energy to the ejection unit; and
an electrical module configured to enable an electrical quick disconnect of portions of the ejectable apparatus from the host vehicle.

3. The ejectable apparatus of claim 1, further comprising an inflatable floatation device configured to be activated in water.

4. The ejectable apparatus of claim 1, further comprising an extended power supply configured to provide power to ejected portions of the ejectable apparatus for an extended period.

5. The ejectable apparatus of claim 1, wherein the memory unit comprises a plurality of sub-memory units, each of the sub-memory units being configured to stored information from a specific one of the plurality of data recording instruments.

6. The ejectable apparatus of claim 1, wherein the connection module is configured to connect the ejectable apparatus to the plurality of data recording instruments via at least one of wired or wireless connections.

7. The ejectable apparatus of claim 1, wherein the predefined criterion occurs prior to an occurrence of a catastrophic event involving the host vehicle.

8. The ejectable apparatus of claim 1, wherein the ejectable apparatus is contained in an electronic enclosure.

9. The ejectable apparatus of claim 1, wherein ejectable portions of the ejectable apparatus are enclosed in a protective enclosure which is configured to protect data stored in the memory unit.

10. The ejectable apparatus of claim 1, wherein the memory unit is enclosed in a protective enclosure which is configured to protect data stored in the memory unit from heat, cold, fluid, radio frequency interferences and impact.

11. A method, comprising:
connecting an ejectable apparatus in parallel to a plurality of data recording instruments in a host vehicle;
separately storing information received from each of the plurality of data recording instruments for a predefined time period in a memory unit of the ejectable apparatus;
monitoring for occurrence of a predefined criterion; and
separating portions of the ejectable apparatus from the host vehicle upon detection of the predefined criterion.

12. The method of claim 11, comprising executing a device locator to indicate a position of ejected portions of the ejectable apparatus after an ejection occurs.

13. The method of claim 11, further comprising supplying a constant source of energy to the ejectable apparatus prior to ejection and enabling an electrical quick disconnect of portions of the ejectable apparatus from the host vehicle upon detection of the predefined criterion.

14. The method of claim 11, comprising executing an inflatable floatation device upon entry of portions of the ejectable apparatus into water.

15. The method of claim 11, further comprising supplying extended power supply configured to provide power to ejected portions of the ejectable apparatus for an extended period.

16. The method of claim 11, wherein the separately storing information comprises separately storing information in a plurality of sub-memory units, each of the sub-memory units being configured to stored information from a specific one of the plurality of data recording instruments.

17. The method of claim 11, comprising connecting the ejectable apparatus to the plurality of data recording instruments via wired or wireless connections.

18. The method of claim 11, wherein the predefined criterion occurs prior to an occurrence of a catastrophic event involving the host vehicle.

19. An ejectable apparatus, comprising:
means for connecting the ejectable apparatus in parallel to a plurality of data recording instruments in a host vehicle;
means for separately storing information received from each of the plurality of data recording instruments for a predefined time period in a memory unit of the ejectable apparatus;
means for monitoring for occurrence of a predefined criterion; and
means for separating portions of the ejectable apparatus from the host vehicle upon detection of the predefined criterion.

20. The ejectable apparatus of claim 11, wherein the ejectable apparatus is one of a plurality of ejectable apparatuses on the host vehicle, wherein each of the plurality of ejectable apparatuses is separated from the host vehicle upon the occurrence of a specific predefined criterion.
